(19) United States
(12) Patent Application Publication
(10) Pub. No.: US 2015/0052074 A1
(43) Pub. Date: Feb. 19, 2015

(54) Threat Identification and Mitigation in Computer-Mediated Communication, Including Online Social Network Environments

(71) Applicant: Ted W. Reynolds, Winter Springs, FL (US)

(72) Inventor: Ted W. Reynolds, Winter Springs, FL (US)

(21) Appl. No.: 14/480,996

(22) Filed: Sep. 9, 2014

Related U.S. Application Data
(63) Continuation-in-part of application No. 13/352,303, filed on Jan. 17, 2012, now Pat. No. 8,838,834.
(60) Provisional application No. 61/433,221, filed on Jan. 15, 2011.

(51) Int. Cl. G06Q 50/26; G06Q 50/00; G06Q 10/00; H04L 29/06

(52) U.S. Cl. CPC G06Q 50/265; H04L 63/30; G06Q 50/01; G06Q 10/00
USPC 705/325

(57) ABSTRACT

A method for monitoring and countering source content that encourages an individual to engage in extremist or terrorist activities. The method comprises: intercepting the source content from a communications stream, the source content initiated by or intended for the individual, determining a threat indicator indicative of the likelihood the individual, after exposure to the source content, will engage in extremist or terrorist activities, and sending counter-narrative content to the individual, the counter-narrative content contrary to the source content in an attempt to discourage the individual from engaging in extremist or terrorist activities.

### CLAIM OF PRIORITY

The present application is a continuation-in-part application of application Ser. No. 13/352,303 filed on Jan. 17, 2012 and entitled Understanding and Combating Radicalization and Recruitment into Extremist/Terrorist Groups in Online Social Network Environments, which application claims priority under 35 U.S.C. section 119(e) to the U.S. Provisional Patent Application assigned application No. 61/433,221 entitled Understanding and Combating Radicalization and Recruitment into Extremist/Terrorist Groups in Online Social Network Environments and filed on Jan. 15, 2011. The contents of both applications are incorporated by reference herein in their entirety.

### FIELD OF THE INVENTION

The various embodiments of this invention monitor computer-mediated communication, including communication through online social networks and web sites, to identify individuals who may engage in extremist or terrorist actions and to mitigate the effects of such communication, by providing counter-narrative communication, to reduce the likelihood of such extremist and terrorist actions by individuals.

### BACKGROUND OF THE INVENTION

As western counter-terrorism efforts have limited the various person-to-person avenues for the spread of extremist ideology by outlawing ‘hate-speech’ in public forums, mosques, and in print, as well as identifying and arresting known terrorist recruiters, these communications have been driven underground and the investment by extremist groups in on-line forums and websites, and the level of participation within these websites, has grown substantially. Increasingly, those arrested on suspicion of terrorism or those actually engaging in terrorist acts indicate they began their ‘journey’ by visiting extremist websites, participating in chat rooms, and watching extremist and/or jihadi videos.

Current research suggests that behavior modification is possible via human-computer interaction. Further, the ability to socially interact on the computer has evolved to the level of real-time communications. This allows for iterative computer mediated dialogue to be considered an equal to face-to-face communication. This change in perception is critical to understanding the interactive effect of extremist websites, online social networks, and other computer-mediated communication (CMC) on individuals considered vulnerable to extremist radicalization.

The potential danger of online radicalization is highlighted in the United Kingdom's Strategy for Countering International Terrorism (March 2009). Noted within this document is the threat posed by “self-starting networks, or even lone individuals, motivated by an ideology similar to that of Al-Qaeda, but with no connection to that organization; and terrorist groups that follow a broadly similar ideology as Al-Qaeda but that have their own identity and regional agenda.” Further, the document acknowledges the role and impact of the Internet in the “two way dialogue between their organizations and their actual or prospective members . . . that enables fundraising, recruitment, and some training and operational planning.” Previous action by far-right/anti-immigration groups and recent calls by extremist Islamists to move out of their password protected chat-rooms and expand onto social network sites like Facebook and Twitter in order to ‘appeal to the masses’, just as they have used YouTube to spread extremist propaganda, is a disturbing development given the trend of online radicalization seen in recent arrests.

At this time the governments monitoring and mitigation capabilities, as they relate to terrorist/extremist online sites, require human beings to monitor and observe postings to the sites. In rare cases counter-narrative content is added but it is often outed by site users as identified government content. For the thousands of sites that are monitored, there are hundreds/thousands of individuals seeking to monitor these sites to find that needle in the hay stack of needles.

### BRIEF DESCRIPTION OF THE FIGURES

FIG. 1 is a functional block diagram of an apparatus for monitoring electronic communication and injecting counter-narrative content as appropriate.

FIG. 2 is a block diagram of a computer system for use in practicing the invention.

FIG. 3 is a flow diagram of monitoring and interdicting steps according to the present invention.

### DETAILED DESCRIPTION OF INVENTION

Before describing in detail the particular apparatuses and methods for identifying threats and mitigating those threats through the use of computer-mediated communication in accordance with the various embodiments of the present invention, it should be observed that these embodiments reside primarily in a novel combination of hardware and software elements related to the claimed apparatuses and methods. Accordingly, the hardware and software elements have been represented by conventional elements in the drawings, showing only those specific details that are pertinent to the presented embodiments so as not to obscure the disclosure with details that will be readily apparent to those skilled in the art having the benefit of the description herein.

The following embodiments are not intended to define limits as to the structures or methods of the invention but only to provide exemplary constructions. The embodiments are permissive rather than mandatory and illustrative rather than exhaustive.

Broadly speaking, the invention teaches a method, apparatus, and software program for identifying extremist or terrorist philosophies in electronic communication and combating those philosophies by interdictive counter-narratives. To facilitate an understanding of the present invention, it is described with reference to specific implementations thereof, but the invention is not limited to the described implementations.

The present invention centers on monitoring computer-mediated communication (CMC) to identify potential threats and implanting mitigating content to counter the ongoing narrative of the group/individual. The primary target of this invention is the monitoring of extremist/terrorist CMC (also referred to as source content or original content) to identify patterns of radicalization and recruitment, to identify threats based on a threat score (also referred to as a threat indicator) obtained from a multivariable threat matrix, and to implement counter-narrative messaging to dissuade users from becoming radicalized and then engaging in terrorist or extremist activities. The counter-narrative content can be sent directly to an individual or to social networking sites. The counter-narrative content sets forth ideas and rational concepts that are contrary or opposed to the extremist/terrorist CMC and thereby attempts to discourage the individual from engaging in such extremist or terrorist activities.

The system and method of the invention is a force multiplier making it possible to monitor multiple individuals or groups simultaneously and to provide an objective evaluation of the threat posed by all users in a data stream. The objectivity of the analysis, based upon the multivariable threat analysis matrix, as described in detail below, is more accurate than the subjective analysis of individual assessments. Such a process is beyond human capabilities where thousands of users are engaged in 24/7 dialog. Further, the system and methods of the invention operate non-stop, without rest, and provide real time assessments of an individual's threat to engage in terrorist/extremist activity as well as real time assessments of the effectiveness of any counter-narrative or mitigating content.

Generally, the embodiments of the present invention analyze multiple variables to determine how the content of computer-mediated communication can facilitate radicalization and formal recruitment into an extremist organization, where such organizations are known to or suspected of carrying out terrorist actions against countries, cultures or religious organizations having views (e.g., religious or cultural) that are anathema to the organization. The multiple variables are presented in equation form, as described below, to generate a numeric threat score indicative of the likelihood that the individual subjected to this content will engage in extremist or terrorist actions reflective of the organization's views. These variables may include, but are not be limited to:

(1) An individual's patterns of participation in such an organization, including exposure to the narratives of the organization and the period during which the individual engages in social learning about the organization. When an individual first begins to visit/interact with a new online environment there is a period of social learning (also known as lurking) during which the individual simply observes group activity to learn the nomenclature and the agenda of the group. Social learning is necessary so the individual participant does not ‘say’ something that might cause him/her to be sanctioned or removed from the group. This period of social learning is likely the most effective time for interdiction as there has been insufficient time for assimilation into the group and adoption of the group's narrative. Such assimilation is indicated by an increase in the frequency of a user's exposure to the organization's narratives and an increase in the use of keywords/phrases that reflect the narrative in extremist/terrorism online environments.

(2) Development of the individual's social network as related to extremist/terrorist activities, including identifying facilitators and recruiters within those networks. Facilitators/recruiters are identified using social network analysis that indicates those individuals who act as communication hubs within the group. It is known through the inventor's ongoing analysis that within the membership of the groups there is a core of participants who account for the majority of the online activity to disseminate the group's narrative and to interact with the general membership. Of the groups studied, these facilitators, who account for the majority of the traffic, represent about 1-2% of the active group membership.

(3) Examining changes in the individual's dialog over time as those changes reflect identification with and acceptance of an extremist narrative. This examination includes an analysis of the use of keywords/phrases that indicate an acceptance of the group's narrative, comments concerning or sharing of URL (uniform resource locator) links that espouse the group's narrative and engagement (e.g., electronic communications) with other members regarding ideological issues.

(4) Linking the extremist dialog with socio-political events/triggers or with exposure to certain extremist content, links or facilitators. Certain events that impact the group (legislation, attacks, arrests, etc.) will provoke a reaction from individuals within the group or that have a connection with that group. Further, how the individual responds to contact with URL links, other extremist content, and facilitators provides a measure of the individual's acceptance of and identification with the extremist narrative. Ongoing research by the inventor indicates that only a subset of about 6-7% of the overall membership actually engage in an ongoing dialog with other group members, and a small subset within this subset engage on a regular basis with other group members. This small subset is the target of such analysis.

(5) Determining the impact of the content associated with embedded URL links on the group and individual narrative and the nature of the content, e.g., motivational or operational. Responses to the URL links, which most often are presented in such a way as to build group solidarity by either reinforcing the group narrative or furthering the us-vs-them paradigm of the membership. The simple fact that an individual responds to content at these links is significant and the nature of that response, which indicates an acceptance or rejection of the narrative, provides a useful measure of the individual's acceptance or rejection of the group's narrative.

(6) Identifying patterns of radicalization and recruitment within the network.

The threat score as generated by the multivariable threat matrix is also used to identify points along the radicalization continuum where targeted counter messaging is most effective (and points where targeted counter messaging is least effective). These mitigating messages include counter-narrative and/or persuasive messages to discourage or dissuade the individual from continued group participation. As a rule, mitigating or counter narrative content is targeted toward a specific group, issue, or content in which the individual user is engaged at that time.

The system of the invention identifies key points within the individual's participation pattern where these interdictions should be most effective. System triggers for this automated implantation include but are not limited to, use of certain keywords/phrases; interaction with certain individuals/facilitators or content known to be most influential within the group; and posting of traffic that would indicate a questioning of the group's narrative (interdictions in this case would serve to reinforce those doubts and move the individual away from the group).

Mitigating content is not limited to textual content. For example, mitigating content may include, but is not limited to, implanting viruses/malware within certain links to cause disruption to users who open those links, disrupting entire web sites, and disrupting certain aspects of site functionality. Current research has shown that the user experience is correlated positively to continued site usage. By creating a negative user experience or creating a sense that the site is not safe, the user will often not return to the site.

As discussed above, it is known that visitors to extremist/terrorist sites engage in a period of social learning to determine whether the content is what they are looking for and they refrain from engagement for a period of time to avoid either being admonished or sanctioned (kicked out) for saying something that is considered wrong by the extremist/terrorist group. Given the lack of full commitment at this time, implanting a private message to a new user (for example, on his/her first visit to the site) indicating that continued use of this site may subject them to investigation and/or arrest would be most effective at dissuading future engagement. If the individual chooses to re-engage, this action is reflected in an escalation of their threat score.

The multivariable threat matrix and its resulting threat score are used to determine whether the individual has reached a “tipping point” or threshold. When this point is reached intervention with counter messages is generally believed to be no longer effective as the counter messages will have less effect on discouraging the individual from engaging in extremist or terrorist activities.

Ongoing research indicates that the multivariable threat matrix includes the cumulative/integrated results of the traffic analysis (how often the individual participates within the group); continued contact with extremist URL links and known facilitators/recruiters; and the increased use of keywords/phrases that indicate an acceptance of and identification with the group narrative, including the use of words/phrases that reveal an indication of pending violent action through a change of agency in the words/phrases that the individual uses. An example of a change of agency can be seen when someone shifts from making a statement like, “I wish those people would just go away”, to a statement like, “I want to kill those people” or even further to, “I'm going to kill those people.”

An example of a quantitative measure of how effective computer-mediated communication can be in facilitating radicalization and formal recruitment into an extremist organization is presented by the multivariable threat matrix equation below, where the calculated quantity is designated a threat score T_{S}.

Multivariable threat matrix variables:

N=Network of individuals in contact with the user

U=User Frequency (generally this variable receives a greater weight than the other variables)

K=Use of Keywords/Phrases

F=Contact with Facilitators

E=External Content (jihadi videos/other extremist URL links)

G=Geographic location (where a change in geographic location may indicate preparation for extremist or terrorist activity)

t=Time

w=weight for each variable where the subscript designates the specific variable

Threat Score T_{S}

[N(w_{N})+U(w_{U})+K(wₖ)+F(w_{F})+E(w_{E})+G(w_{G})]/t=T_{S}

A numeric value for each variable is typically established by a subject matter expert who is familiar with the group/environment, keeping in mind that the number and subject of the variables can/will change depending on the group/environment.

The threat score is a calculation of the cumulative effect of the differently weighted variables in relation to time (which serves as a utility function). The larger the value of T_{S} the more likely the individual has adopted terrorist philosophies, which may lead to terrorist or extremist actions.

The variables within the threat matrix equation are not limited to those shown herein. Thus the equation presented is a non-limiting example. The number of variables and the specific weighting of each variable can be changed depending on the threat environment (e.g. size of the network, presence of facilitators, total frequency, etc.).

The threat score T_{S} is a numeric value, in one embodiment on a scale from 0-100, with an increase in score/value indicative of an increase in threat. The scale can be changed depending on the granularity desired from the multivariable threat matrix. Further, the variables and weighting factors for a terrorist analysis are different from those for identifying and evaluating online human trafficking or cyber-bullying, which are other applications of the concepts of the present invention.

A tipping point or threshold is reached when the threat score (T_{S})) reaches a predetermined value that suggests an imminent threat to people or property based upon longitudinal observation and measurement or a predetermined value that suggests additional counter narrative interdictions will have little or no effect on the individual. The tipping point value for T_{S} is selected by the user (e.g., a subject matter expert) and can be adjusted for a specific threat environment. The predetermined value that suggests an imminent threat and the predetermined value that suggests additional counter narrative interdictions will have little effect may be the same or different values.

Use of the threat score equation above allows for implantation of mitigating/counter narrative content and the measurement of the effectiveness of the mitigating/counter narrative content by observing changes in the threat score value for an individual following his/her exposure to the mitigating/counter narrative content.

Several references are made herein to terrorist or extremist activities or content. Multiple examples of such content and activities can include but are not limited to:

Jihadi Sermons by key al-Qaeda figures like Anwar Awlaki. Video's of suicide attacks that can include inspirational music Beheading videos

Calls to engage in violent extremism/terrorism either domestically or internationally

Inspire Magazine, which is an English only online jihadi magazine with inspirational messages, bomb making instructions, and other jihadi content, including links to Inspire, copies of Inspire articles, and the sharing of files containing issues of Inspire.

Promoting extremist/terrorist action

Making financial or material donations to extremist/terrorist groups or organizations supporting those groups

Engagement with or sharing of training videos

Making travel arrangements

Providing material support for those actively engaged in terrorist/extremist activities

Performing intelligence gathering and/or disseminating operational/tactical information

Other activities identified by law enforcement or counter-terrorism agencies as indicators of extremist/terrorist activity

A list of keywords and phrases (a component of the third variable above and parameter “K” in the multivariable threat matrix) for analysis by the threat matrix will be specific to the group/site being monitored. Area specialists or subject matter experts within government and law enforcement communities can provide lists of relevant keywords and phrases or lists can be compiled based on a content analysis of a sample of Internet traffic. In a jihadi environment certain words or phrases have significant meaning. As an example use of the word Shaheed indicates someone is either about to be or has become a martyr. Additionally, discussions of a “caliphate,” references to specific western targets (NY Stock Exchange, Sears Tower, US Embassy), references to specific weapons to be used (airplanes, bombs, device, guns, references to mass casualty weapons), references to specific individuals being targeted (regional police chief, ambassador, president, general, etc.) are important keywords. Also action words like attack, kill, exterminate, eliminate, etc. are important keywords.

The present invention analyzes the impact of the electronic communication stream and the development of the extremist narrative and its component parts, as reflected in the discourse within the computer-mediated communication, by using collection and analytical tools that facilitate a multi-level cascading statistical analysis of the collected information.

Further, the invention includes an integrated messaging component that allows implantation of counter-narrative messages/interdictions within the CMC stream and the ability to measure the impact of those messages on a user. In one embodiment these counter-messages are automatically implanted when the individual uses certain keywords and phrases. Further, contact with certain content or individuals that includes but is not limited to extremist URL links, and facilitators/recruiters can also trigger the implantation of prepared counter-messages that are context-specific and stored within the system. As an example, if an individual who is participating within a jihadi site comes in contact with a video of an Anwar al-Awlaki sermon, a previously-prepared counter message by a well known Islamic scholar would be sent to counter the influence of the Awlaki video and create doubt within the individual and the group.

The hardware/software components of the invention automatically monitor computer mediated communications to identify, analyze and attempt to determine the effect of these communications on the individual, identify those individuals who are most susceptible to this persuasion, and implant automated and manual interdictions that allow for the deceleration of the individual identification with the narrative of the group they are engaged with. The nature, content and frequency of the counter-narrative interdictions can be tailored based on the degree to which the individual has adopted the group's extremist or terrorist narrative (as reflected by the individual's T_{S} numerical value, which through observation of the threat score following certain interactions can also provide an indication of the individual's susceptibility to persuasion by other members of the group).

In the realm of extremist groups, the system monitors the computer-mediated communication of these groups and individuals, identifies those individuals who are on the path to accepting the extremist narrative (by evaluating the level and extent of their participation within the group, their use of keywords/phrases that indicate an identification with and acceptance of the extremist narrative, and their increased participation/interaction with known facilitators/recruiters, for example). The system provides automated interdictions (i.e., mitigating content or counter-narrative messages) that seek to dissuade these individuals from continuing along this path. The system includes metrics, based upon the individual's interaction with and response to the implantation, including the analysis of the response content and whether the individual shares this content with others or uses it in future CMS's, to determine whether these interdictions are effective and if the individual's identification with the extremist narrative continues unabated and reaches a point of no return as determined by the described multivariable threat matrix. At this point the system identifies the individual as a potential threat and may place him/her on a list for more in-depth investigation.

This system allows for the monitoring and interdiction of hundreds of groups at any given time, in real time, and therefore provides a significant reduction in current man-hours required to monitor these same groups.

### Data Collection/Processing

Data collection and analysis is performed on a live data stream in real time. Alternatively, the data can be stored and analyzed later. In one embodiment collection and analysis rates are estimated at 40 gigabytes/second. The invention is designed to allow for the application of functions previously mentioned for various usages. This is made possible by the establishment of the “plug and play” capabilities of the system. The end user of the data collection system determines the groups to be monitored and the key determinants of participation, interaction, and keywords and phrases that the system will use to conduct the analysis and apply to the multivariable threat matrix. A graphical user interface allows the user to input the initial analysis parameters. This functionality also allows for the continued modification or addition of critical search information as group dynamics change. Based upon the user input, the system provides group-specific monitoring, analysis, and threat identification.

It is important to note that the term ‘computer mediated communication’ (CMC) as used herein is not limited to communications only from/by/to computers. The ability to engage in CMC from mobile devices, which include but are not limited to, cell phones, PDA's, iPad's, etc., and the ability of the system to monitor these communications, extends the capability of the system to detect threats within CMC originating from/involving multiple communications platforms and systems.

### Data Analysis

To understand the potential influencing factors within these communications, particularly within and extremist/terrorist environment, several separate analyses are performed simultaneously on the data stream. These include a network analysis, e.g., an analysis of an individual's network of friends/associates and his/her communications between and among those friends, and an identity of those in the communications network. This process also allows for the identification of facilitators within the social network, content or discourse analysis, and an analysis of the URL links found within the comments/posts.

Key to understanding the long term effect of exposure to the extremist narrative within these groups, the network and content analyses can be linked to determine how discourse may change over time to indicate assimilation and identification with the radical ideology/narrative. Additionally, the content analysis is used to understand the influence of URL links within the posts, email, instant messages or text messages. Lastly, the individual URL links are analyzed to consider their virility and effectiveness as persuasive agents. The URL's are a key to understanding the persuasive nature of the information (for example video's) within the group. If a particular video/link is associated with an uptick in aggressive/flaming dialogue (which is an indicator of increased acceptance of the extremist narrative) it is then possible to develop and interdict counter-narrative links and messages to offset the influencing nature of a particular video/link.

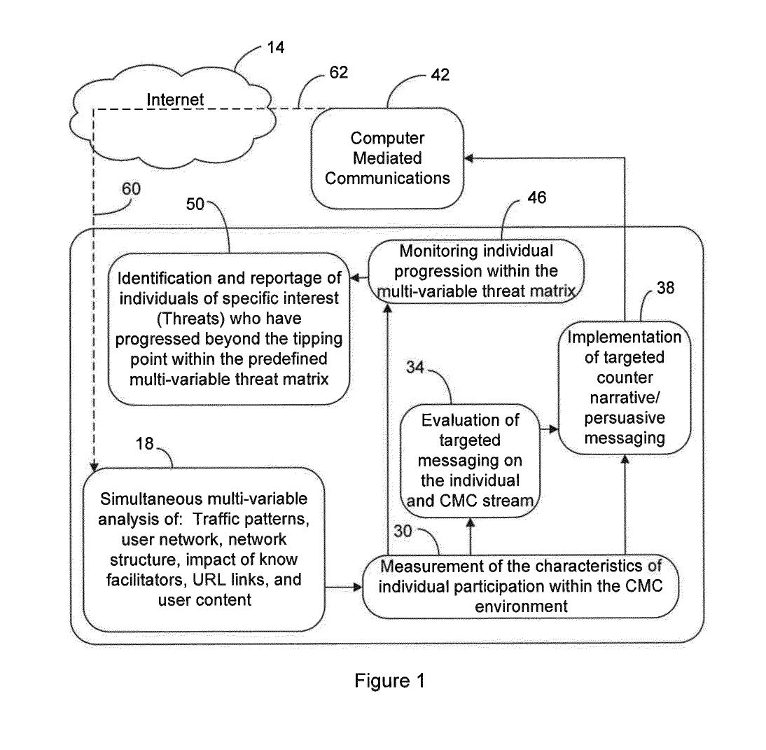

FIG. 1 depicts the functioning of a monitoring and interdiction system 10 of the present invention. Generally, FIG. 1 is a visual representation of operation of the monitoring, interdiction, threat identification product of the present invention. Computer mediated communications are subjected to a multi-variable analysis. The characteristics of the individual's participation are measured to determine the need for the implantation of targeted messaging and the level of messaging required. The continued responses from the user dictate the level of targeted interdiction by the system as the feedback loop that allows the system to measure the effectiveness of previous interdictions.

A measuring function also allows the system to determine when a user's online dialogue/usage has reached a point of serious concern based upon the predetermined multivariable threat matrix. Once this “tipping point” or threshold is reached the individual is identified as a possible threat for more detailed consideration.

The system 10 accesses electronic communication occurring over the Internet 14. A functional block 18 conducts a multivariable analysis of the electronic communication, including analysis of traffic patterns, user networks, social network structure elements, impact of known facilitators, identified URL links, URL links that have been accessed and extremist/terrorist content within the electronic communication. In one embodiment the functional black 18 implements the multivariable threat matrix described elsewhere herein. A functional block 30 receives the results from the block 18 (e.g., the threat score T_{S}) and measures characteristics of an individual's participation within the CMC environment based on one or more factors described above, e.g., content of initiated emails and instant messages, web sites visited, association (frequency of communication and nature of that communication) with other group members who have adopted the extremist narrative. Essentially the functional block 30 dictates the what, when, and how for implanting the counter-narrative content and further measures the effectiveness of the counter-narrative content based on subsequent actions of the monitored individual.

Once the system has determined the degree to which the target narrative has been adopted within the functional block 30, a block 34 evaluates available counter-narratives and persuasive content for rebutting the target extremist narrative with respect to the individual and the CMC stream. At a block 38 the counter-narrative and persuasive messages are prepared for inputting into the individual's data stream (e.g., through emails, text messages, instant messages, invitations to web sites presenting the counter-narrative). A computer mediated communication element 42 inputs the counter-narrative content to the individual's data stream on the Internet 14, such as by sending emails, text messages, instant messages or URL links.

A functional block 46, also receiving the threat score T_{S}, monitors an individual's progression along the radicalization continuum and identifies any such individuals who have progressed “beyond the tipping point” or beyond the threshold according to the multivariable threat matrix. These individuals are reported to a functional block 50.

Data flow paths 60 and 62 depict publicly-available data flows.

While this system/device was originally designed for the monitoring, analysis, and threat identification within extremist/terrorist computer mediated communication, it also has conventional commercial applications, examples of which are described below.

The monitoring of communications within a network for corporate threats. These may include, but are not be limited to:

a. E-mails or downloads from within or without that may contain viruses/bots that may be considered threats to the network.

b. Communications from within or without the network that indicates activity related to corporate espionage.

c. Access within the network to highly sensitive information by individuals/systems from within or without the network who are not authorized to access such information.

System identification of certain keywords/phrases within CMC's as well as contact with certain known threats would trigger an alert. Further, unauthorized access to files would be facilitated by the linkage of a ‘cleared list’ and/or a ‘no copies order’ to the monitoring/search function of the system to identify anyone engaging in unauthorized access/copying of sensitive material.

The monitoring of electronic communication can also identify threats to corporate brands. Brand protection is essential in the corporate world and the identification of threats to these brands within CMC/cyberspace can prove invaluable, given the ability of the system to provide real time identification of these threat to allow for mitigation before the information reaches critical mass (i.e., goes “viral”).

Law enforcement officials can monitor criminal networks or simply monitor CMC to look for criminal activity, planning, behavior and actions within the CMC communication stream. These analytics can be used as an investigative tool. Additionally, the findings can potentially be used as evidence or as a means of truth detection when questioning suspects.

The military can use the system ‘in theater’ to measure the potential for threats in a given area by monitoring the CMC within that area.

This hardware/software can allow political campaigns to monitor online communications within public forums toward identifying threats to their candidate/cause, which is very similar to the corporate brand protection paradigm described above.

The present invention can also serve to identify individuals who are prone to bully others. In this application the variables associated with the multivariable threat matrix are changed to reflect bullying attributes and related communication. Within the bullying scenario, the bullying analysis would be rooted in a library of “hurt words/phrases” developed by a specialist in this field. These include but are not limited to the use of “hurtful”, derogatory, racist, or sexist words or phrases which could include fatty, stupid, bitch, slut, faggot, etc., where the frequency of use would suggest bullying; posting of embarrasing, or suggestive photos meant to cause distress to the individual being targeted; discussion among users about a third party where the discussion is meant to create an unfavorable image or opinion of that third party. This system would include a library for every ‘event’ and a notification function when the bullying activity exceeded the established threshold (such a threshold might be established based on frequency of events within a given time period with certain examples representing a once only case for alert based upon weighting). Such a notification requires that the responsible person/entity actually view the interaction, through the system, to determine if/what action is required. System notifications include an alert function within the graphic user interface, and a text or automated call to the responsible party to notify them of an incident requiring their attention. As an example, if a school wished to monitor all Facebook traffic by the student body for bullying, they might create a Facebook profile for the school mascot and have all of the students “friend” the mascot. As school news and announcement can be dissiminated through this outlet there is an incentive for participation. With all students having “friended” the mascot, the Facebook activity of the student body is available to the system for analysis.

This system provides an in-depth analysis of computer mediated communication toward the identification of threats within a predetermined multi-variable threat matrix. It also includes the ability to implant targeted content to counter the ongoing narrative, and measure the impact of that content on the users and the ongoing stream of CMC.

Systems/software for collecting and analyzing the data has considerable potential as a valuable tool in social science research. Further, the analysis fills a huge gap in terrorism studies literature regarding understanding the influence/role of extremist social networking sites in the radicalizing process.

These processes are also useful in understanding the use of these techniques in product marketing as well as in the area of political persuasion in legitimate political campaigns. Social networking and computer-mediated communication are becoming an integral part of western life with research and system just now beginning to understand the true impact and persuasive nature of these interactions on the individual.

It is clear that extremist/terrorist groups are utilizing computer mediated communication including social networking sites like Facebook and Twitter (to name just a few) to radicalize vulnerable individuals and build a pool of recruits. The ability to counter these efforts should be considered an integral part of combating terrorism, and more specifically combating the efforts to create “homegrown terrorists.” It is known that extremist or terrorist CMC is also communicated via electronic mail, land-line telephones, mobile telephones, over the internet as a part of social networking sites or otherwise, in face-to-face communications (which can be captured by surveillance techniques and devices), other wire-based communications, over free-space communications (i.e., the propagation of radio frequency signals), text messages, twitter tweets, and instant messages.

The embodiments of the present invention may be implemented in the general context of computer-executable instructions, such as program modules executed by a computer. Generally, program modules, e.g., routines, programs, objects, components, data structures, perform particular tasks or implement particular abstract data types. For example, the software programs that underlie the invention can be coded in different languages for use with different platforms. The principles that underlie the invention can be implemented with other types of computer software technologies as well.

Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program features for executing the method of the invention.

Also, an article of manufacture, such as a pre-recorded disk or other similar computer program product, for use with a data processing system, could include a storage medium and a program stored thereon for directing the data processing system to facilitate the practice of the method of the invention. Such apparatus and articles of manufacture also fall within the spirit and scope of the invention.

The present invention can be embodied in the form of computer-implemented processes and apparatuses for practicing those processes. The present invention can also be embodied in the form of computer program code containing computer-readable instructions embodied in tangible media, such as floppy diskettes, CD-ROMs, hard disks, flash drives or any other computer-readable storage medium, wherein, when the computer program code is loaded into and executed by a computer or processor, the computer or processor becomes an apparatus for practicing the invention. The present invention can also be embodied in the form of computer program code, for example, whether stored in a storage medium or loaded into and/or executed by a computer, wherein, when the computer program code is loaded into and executed by a computer or processor, the computer or processor becomes an apparatus for practicing the invention. When implemented on a general-purpose computer, the computer program code segments configure the computer to create specific logic circuits or processing modules.

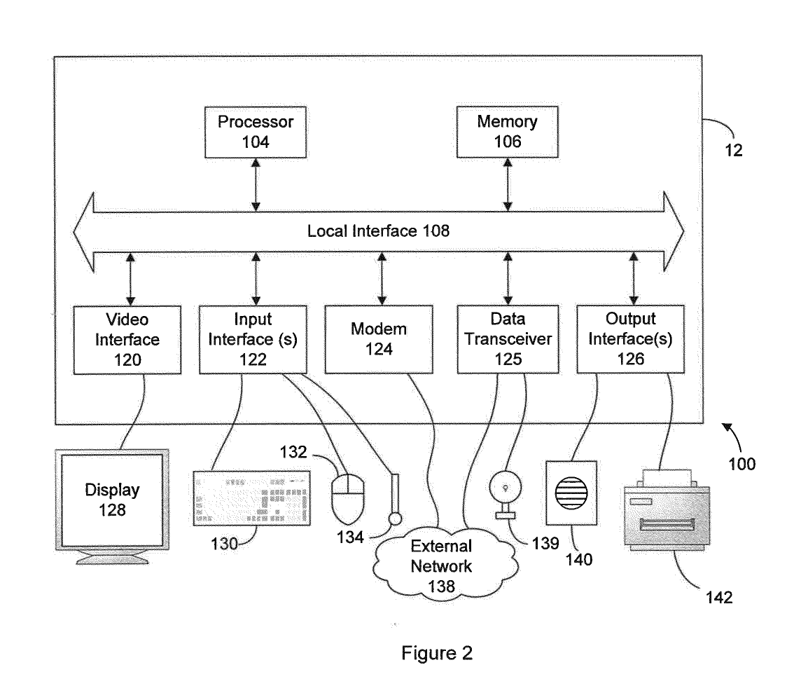

FIG. 2 illustrates a computer system 100 for use in practicing the invention. The system 100 can include multiple local or remotely-located computers and/or processors. The computer system 100 comprises one or more processors 104 for executing instructions in the form of computer code to carry out a specified logic routine that implements the teachings of the present invention. The computer system 100 further comprises a memory 106 for storing data, software, logic routine instructions, computer programs, files, operating system instructions, and the like, as is well known in the art. The memory 106 can comprise several devices, for example, volatile and non-volatile memory components further comprising a random access memory RAM, a read only memory ROM, hard disks, floppy disks, compact disks including, but not limited to, CD-ROM, DVD-ROM, and CD-RW, tapes, flash drives and/or other memory components. The system 100 further comprises associated drives and players for these memory types.

In a multiple computer embodiment, the processor 104 comprises multiple processors on one or more computer systems linked locally or remotely. According to one embodiment, various tasks associated with the present invention may be segregated so that different tasks can be executed by different computers located locally or remotely from each other.

The processor 104 and the memory 106 are coupled to a local interface 108. The local interface 108 comprises, for example, a data bus with an accompanying control bus, or a network between a processor and/or processors and/or memory or memories. In various embodiments, the computer system 100 further comprises a video interface 120, one or more input interfaces 122, a modem 124 and/or a data transceiver interface device 125. The computer system 100 further comprises an output interface 126. The system 100 further comprises a display 128. The graphical user interface referred to above may be presented on the display 128. The system 100 may further comprise several input devices including, but not limited to, a keyboard 130, a mouse 131, a microphone 132, a digital camera and a scanner (the latter two not shown). The data transceiver 125 interfaces with a hard disk drive 139 where software programs, including software instructions for implementing the present invention are stored.

The modem 124 and/or data receiver 125 can be coupled to an external network 138 enabling the computer system 100 to send and receive data signals, voice signals, video signals and the like via the external network 138 as is well known in the art. The system 100 also comprises output devices coupled to the output interface 126, such as an audio speaker 140, a printer 142, and the like.

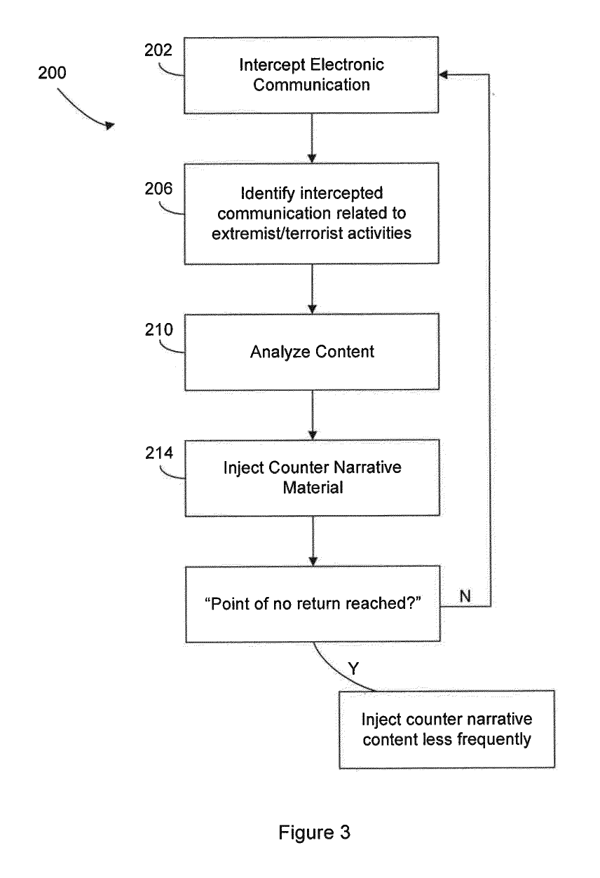

FIG. 3 is a flow chart 200 for implementation by the computer system 100 of FIG. 2. The flowchart 200 begins at a step 202 where electronic communication intended for or initiated by the individual is intercepted. At a step 206 the intercepted electronic communication that relates to extremist or terrorist actions is identified. The content of the electronic communication is analyzed at a step 210 to determine the nature of the content, the senders and recipients, referenced URL links, etc. At a step 214 counter-narrative material is injected into the individual's communication stream as warranted, for example according to the threat score T_{S}. The content of the counter-narrative material is determined based on the content of the intercepted extremist/terrorist communication, with the intent of countering that content or supporting a shift away from the extremist/terrorist narrative. Step 218, again using the results of the prior analysis of the intercepted communication, attempts to determine whether the individual has progressed beyond a “tipping point.” This conclusion (which is not definitive given the nature of the content analysis, but merely provides an indication) is based on the described multivariable threat matrix. It is surmised that once the individual as reached this “tipping point” additional injections of counter-narrative content will have less effect on countering the extremist/terrorist content. Thus such content may be injected less frequently as indicated at a step 222. If the individual has not reached the “tipping point” the process continues to the step 202.

To address the concerns of US law enforcement and other US entities, one embodiment of the present invention provides for the anonymization of the monitored individuals by using a numeric value to represent those individuals. This value is not an actual text string of the individual, but rather a cipher of the original text that was derived using an algorithmic function f(x) that contains exponential, multiplication and summation components using a prime number as a spreading method.

The purpose of this cipher is two-fold. First, it is highly unlikely that two non-identical strings will yield the same cipher value. Second, it imposes a reasonable level of difficulty such that it could not be easily reverse computed back to the subject string, such as with a hash or simple substitution. The goal is to create a one-way cipher that neither inherently contains the number of characters nor the value of those characters. According to Bruce Schneier (1996) in Applied Cryptography, a one-way cipher, also called a one-way function, is “relatively easy to compute, but significantly harder to reverse. That is, given x it is easy to compute f(x), but given f(x) it is difficult to compute x. In this context, “hard” may be defined as requiring millions of years to compute x from f(x), even if all the computers in the world were assigned to the problem. More generally, the difficulty in reverse engineering f(x) is analogous to trying to unscramble eggs. Before scrambling, the individual eggs are easily identifiable, but once scrambled it is impossible to separate the eggs back into their previous state. Even with the advances in computing power since this text was written in 1996, the one-way cipher offers a more than reasonable assurance that user names cannot be easily reverse engineered from the anonymized value f(x) that is used to identify the data set.

The numeric value generated by the one way cipher allows for a more efficient compilation and analysis of the user data over time. Further, once the user has progressed beyond the threshold as determined by the threat matrix, the system can reverse the cipher and identify the individual for further investigation and/or action. If the individual of concern is revealed to be a US citizen, this identification (as having passed beyond the threshold) could be viewed as probable cause to open a full investigation on the individual for possible engagement in terrorist/extremist activities.

Social network sites or services referred to herein are typically online service platforms or sites that focus on building and reflecting social networks or social relations among people, who, for example, share interests and/or activities. A social network service consists of a representation of each user (often a profile), his/her social links, and a variety of additional services. Most social network services are web-based and provide means for users to interact over the Internet, such as e-mail and instant messaging. Online community services are sometimes considered as a social network service, though in a broader sense, a social network service usually means an individual-centered service, whereas online community services are group-centered. Social networking sites allow users to share ideas, activities, events, and interests within their individual networks.

While the invention has been described with reference to various embodiments, it will be understood by those skilled in the art that various changes may be made and equivalent elements and process steps may be substituted for elements thereof without departing from the scope of the present invention. The scope of the present invention further includes any combination of the elements and process steps from the various embodiments set forth herein. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

What is claimed is:

1. A method for monitoring and countering source content that encourages an individual to engage in extremist or terrorist activities, the method comprising:
(a) intercepting the source content from a communications stream, the source content initiated by or intended for the individual;
(b) determining a threat indicator indicative of the likelihood the individual, after exposure to the source content, will engage in extremist or terrorist activities; and
(c) sending counter-narrative content to the individual, the counter-narrative content contrary to the source content in an attempt to discourage the individual from engaging in extremist or terrorist activities.

2. The method of claim 1 further comprising a step (d) determining when the individual has progressed beyond a threat indicator threshold and responsive thereto discontinuing execution of step (c).

3. The method of claim 1 wherein responsive to a predetermined threat indicator value the individual is identified as an individual of interest.

4. The method of claim 1 wherein responsive to a predetermined threat indicator value extremist or terrorist activities are imminent.

5. The method of claim 1 further comprising anonymizing an identity of the individual until a predetermined threat indicator is determined, responsive thereto further comprising revealing the identity of the individual.

6. The method of claim 1 wherein the communications stream comprises any one of electronic mail, land-line telephones, mobile telephones, content carried over the internet, face-to-face spoken communications, wire-based communications, free-space communications, text messages, twitter feeds, instant messages, web sites, comments posted to web sites, forums, video sites, images, new sites, blogs, and social networks.

7. The method of claim 1 wherein step (a) further comprises identifying a sender of the source content.

8. The method of claim 1 wherein step (b) further comprises comparing information in a current source content with information in a prior source content to determine whether there has been an increase in use of predetermined keywords and phrases that relate to extremist or terrorist activities, or an increase in the frequency at which the individual engages in online activity related to extremist or terrorist activities, or an increase in contact with known facilitators/recruiters, or changes in the individual's geographic location.

9. The method of claim 1 further comprising determining when an individual first engages or visits any one of predetermined extremist or terrorist web sites or social media, responsive thereto executing step (c).

10. The method of claim 1 further comprising identifying facilitators or recruiters associated with the source content and identifying patterns of communication between known facilitators or recruiters and the individual.

11. The method of claim 1 further comprising identifying source content related to planned extremist or terrorist actions and correlating the source content with subsequent actual extremist or terrorist actions.

12. The method of claim 1 further comprising determining elements within the source content and executing step (c) using counter-narrative content responsive to the determined elements.

13. The method of claim 1 wherein the threat indicator comprises a threat score T_{S} determined from a multivariable threat matrix, wherein
[N(w_{N})+U(w_{U})+K(wₖ)+F(w_{F})+E(w_{E})+G(w_{G})]/t=T_{S}
where
N=Network of individuals in contact with the user
U=User frequency
K=Keywords/phrases
F=Contact with Facilitators
E=External Content
G=Geographic location
t=Time
w=weight for each variable where a subscript designates the specific variable

14. The method of claim 1 wherein step (a) further comprises accessing web sites, social network sites and other computer mediated communication that have been identified as promoting extremist or terrorist activities to intercept the source content.

15. The method of claim 1 wherein step (b) is executed in real-time.

16. The method of claim 1 wherein the extremist or terrorist activities comprise jihadi sermons by al-Qaeda members, suicide attack videos, inspirational music inciting to violent actions, beheading videos, solicitations to engage in violent actions either domestically or internationally, references to Inspire magazine, copies of Inspire magazine articles, bomb-making or weapon-making instructions, jihadi-authored content, sharing of files containing issues of Inspire.

17. The method of claim 1 wherein step (b) comprises determining whether the content includes predetermined keywords or phrases.

18. The method of claim 17 wherein the predetermined keywords or phrases comprise any one of Shaheed, martyr, caliphate, kill, exterminate, eliminate, references to specific western targets, references to specific weapons, references to mass casualty weapons, and references to specific targeted individuals.

19. A computer program product for executing by a computer, the computer program product for monitoring and countering source content that encourages an individual to engage in extremist or terrorist activities, the computer program product comprising:
computer readable program code modules stored in a memory of a computer for executing by the computer, the computer readable program code modules comprising:
a computer readable first program code module for intercepting the source content from a communications stream, the source content initiated by or intended for the individual;
a computer readable second program code module for determining a threat indicator indicative of the likelihood that the individual, after exposure to the source content, will engage in extremist or terrorist activities; and
a computer readable third program code module for sending counter-narrative content to the individual, the counter-narrative content contrary to the source content and attempting to discourage the individual from engaging in extremist or terrorist activities.

20. A computer system comprising:
a processor;
a display;
a communications component for controllably intercepting source content from a communications stream, the source content initiated by or intended for an individual;
the processor for determining a threat indicator indicative of the likelihood that the individual, after exposure to the source content, will engage in extremist or terrorist activities;
the processor for sending counter-narrative content to the individual, the counter-narrative content contrary to the source content and attempting to discourage the individual from engaging in extremist or terrorist activities; and
the display for displaying text associated with any one of the source content, the threat indicator, and the counter-narrative content.
